(19) United States
(12) Patent Application Publication
(10) Pub. No.: US 2025/0369744 A1
(43) Pub. Date: Dec. 4, 2025

(54) MICROSCOPE INCLUDING INTERFEROMETER

(71) Applicant: Board of Trustees of Michigan State University, East Lansing, MI (US)

(72) Inventors: Marcos DANTUS, Okemos, MI (US); Sergei Vladimirovich ANISHCHIK, East Lansing, MI (US)

(73) Assignee: Board of Trustees of Michigan State University, East Lansing, MI (US)

(21) Appl. No.: 19/226,640

(22) Filed: Jun. 3, 2025

Related U.S. Application Data
(60) Provisional application No. 63/655,757, filed on Jun. 4, 2024.

(51) Int. Cl. G01B 9/02001; G01B 9/02; G01B 9/02055; G01B 9/02091

(52) U.S. Cl. CPC G01B 9/0201; G01B 9/02011; G01B 9/02041; G01B 9/02067; G01B 9/02074; G01B 9/02091

(57) ABSTRACT

A system and method include a microscope with an interferometer. Another aspect of an optical microscope with interferometry includes tilting a reference mirror and/or a sample offset from a centerline of an adjacent objective or telescope lens. A further aspect provides a microscope system and method which are configured to simultaneously detect a fringe pattern with a phase-shift using light polarization in a single-shot.

### CROSS-REFERENCE TO RELATED APPLICATION

The present application claims priority to U.S. Provisional Patent Application Ser. No. 63/655,757, filed on Jun. 4, 2024, which is incorporated by reference herein.

### BACKGROUND AND SUMMARY

The present disclosure generally pertains to a microscope and more particularly to a 3D microscope including an interferometer.

Linnik, Mirau and other known interferometers typically have a large size, require tedious alignment and need noise-isolation. Furthermore, these traditional devices are challenging to achieve a repeatable auto-reference to absolute zero, delay position. Conventional Linnik and Mirau interferometers are disclosed in U.S. Patent Publication No. 2024/0035810 entitled “3D Profilometry with a Linnik Interferometer” which published to Manassen, et al. on Feb. 1, 2024; U.S. Pat. No. 11,761,753 entitled “Thin Films and Surface Topography Measurement Using Polarization Resolved Interferometry” which issued to Kamenev on Sep. 19, 2023; and U.S. Pat. No. 2,612,074 entitled “Interferometer” which issued to Mirau on Sep. 30, 1952. All of these patents and patent publications are incorporated by reference herein.

A conventional 3D optical microscope using a Linnik interferometer is discussed in Lehmann, P., et al., “3-D Optical Interference Microscopy at the Lateral Resolution,” Int'l J. of Optomechatronics, vol. 8, pp. 231-241 (2014). The Lehmann publication notes that “phase jumps appear” arising “from fringe order errors based on the envelope evaluation result . . . ” (Lehmann at p. 237) and “the measured profile doesn't show the correct amplitude” (Lehmann at p. 240). Significantly, Lehmann uses structured illumination microscopy and does not simultaneously detect a fringe pattern with different phase shifts using light polarization in a single-shot approach.

Wu, C., et al., “Influence of Reference Mirror Tilting on the Performances of a Michelson-Type Interference-Microscope Objective,” Proc. of SPIE, vol. 13155, p. 1315503 (2024) discusses an experiment using a tilted reference mirror at a very small angle of less than 0.39°. It appears that this experiment pre-set this minor tilt angle prior to light emission and that the single objective lens focused the light passing through its beam splitter on the reference mirror.

In accordance with the present invention, a system and method include a microscope with an interferometer. Another aspect of an optical microscope with interferometry includes tilting a reference mirror and/or a sample offset from a centerline of an adjacent objective or telescope lens. A further aspect provides a microscope system and method which are configured to simultaneously detect a fringe pattern with a phase-shift using light polarization in a single-shot, also known as a single camera image. Yet another aspect of the present microscope includes single-shot, polarization-sensitive detection based on a Linnik interferometer. A software program used with optical microscope interferometry is also provided.

An aspect of the present method using a microscope with an interferometer includes: emitting an input light emission to the interferometer; splitting the light emission into a reference path and a sampling path; reflecting the light emission in the reference path with the reference mirror; polarizing the light emission of the reference path between the splitting and the reflecting with the reference mirror; changing an optical characteristic of the light emission in the sampling path with a sampling objective or telescopic lens; reflecting the light emission in the sampling path with a sample; polarizing the light emission of the sampling path between the splitting and the reflecting with the sample; phase-shifting at least one of the reflected light emissions; transmitting the reflected light emission from the reference path and the reflected light emission from the sampling path to a polarized detector; and capturing a 3-dimensional image of the sample with the detector using a single shot illumination. A further aspect of a method of using a microscope with an interferometer, includes: emitting an input light emission to the interferometer; splitting the light emission into a reference path and a sampling path; changing an optical characteristic of the light emission in the reference path with a reference objective or telescopic lens; reflecting the light emission in the reference path with the reference mirror; changing an optical characteristic of the light emission in the sampling path with a sampling objective or telescopic lens; reflecting the light emission in the sampling path with the sample; tilting the reference mirror relative to the reference objective or telescopic lens during the light emission; and capturing a 3-dimensional image of the sample with a detector.

In one configuration, a polarizing camera causes phase-shifting by including four different polarization angles. This system and method use polarized light and quarter wave plates. In another configuration, a reference mirror is oscillated such that a camera takes pictures at 6 (or more) different positions every half-oscillation cycle. This system and method accomplish phase shifting, and do not require polarizers or waveplates. Various of the present embodiments may employ a polarizing camera and/or tilt a reference mirror and/or are compatible with short wavelength light.

The present system and method are advantageous over conventional devices. For example, the present system beneficially allows a user to observe a sample whose surface is at a significant offset angle from a nominal plane perpendicular to an objective or telescope lens centerline. This makes it possible to measure or image a sample with a complex surface shape, such as a steeply projecting pyramid, cylinder or other polygon, by adjusting a reference mirror as needed, while the spatial resolution is maintained.

The present microscope and method are also more reliable due to use of phase-shifting interferometry to produce high-quality images of a sample. It allows the use of low-coherence light, which eliminates speckles and interference not directly related to the sample. Additionally, the present microscope and single-shot method advantageously minimizes or eliminates vibration and drift. The present single-shot method enables quick acquisition of an interference pattern, exhibits low sensitivity to vibrations, and facilitates observation of object motion, based on the manipulation of light polarization and/or phase shifting.

The present configuration of the microscope makes it easy to change objective lenses and observe a variety of samples. With the present phase-shifting method, a spatial resolution is perpendicular to the sample surface of about 10 nm and can reach 0.3 nm with an atomically flat reference mirror. In addition, a significant angular offset of the reference mirror and/or sample from the axis of the objective, may optionally be employed. Additional advantages and features of the present system will become apparent with reference to the following description and claims, as well as the appended drawings.

### BRIEF DESCRIPTION OF THE DRAWINGS

FIG. 1 is a diagrammatic view showing a first embodiment of the present microscope;

FIG. 2A is a contour graphic image of a sample obtained using the present microscope with single-shot phase-shifting;

FIG. 2B is a 3D image of the sample obtained using the present microscope with single-shot phase-shifting;

FIG. 3A is an image of a diamond sample obtained using the present microscope in reflective light;

FIG. 3B is an image of the phase-shift Φ(x,y) of the diamond sample obtained using the present microscope with phase-shifting;

FIG. 3C is a contour graphic image of the diamond sample obtained using the present microscope with phase-shifting;

FIG. 3D is a 3D image of the diamond sample obtained using the present microscope with phase-shifting;

FIG. 4A is a contour graphic image of a red blood cell sample obtained using the present microscope with phase-shifting;

FIG. 4B is a 3D image of the red blood cell sample obtained using the present microscope with phase-shifting;

FIGS. 5A-C are images showing fringed patterns using a holographic reflective grating with different orientations of a sample and a reference mirror of the present microscope;

FIGS. 6A and 6C are contour graphic images showing the fringed patterns using a holographic reflective grating with different orientations of the sample and the reference mirror from Figures A and C, of the present microscope;

FIGS. 6B and 6D are 3D graphic images showing the fringed patterns using the holographic reflective grating with different orientations of the sample and the reference mirror from Figures A and C, of the present microscope;

FIG. 7 is a perspective view showing the present microscope attached to a gantry for substrate manufacturing;

FIGS. 8A and B are software logic diagrams used with the present microscope;

FIG. 9 is a diagrammatic front view showing a second embodiment of the present microscope;

FIG. 10 is a diagrammatic side view, taken in the direction of arrow A from FIG. 9, showing the second embodiment of the present microscope;

FIG. 11 is a diagrammatic side view, taken in the direction of arrow B from FIG. 9, showing the second embodiment of the present microscope;

FIG. 12 is a diagrammatic front view showing a third embodiment of the present microscope;

FIG. 13 is a diagrammatic side view, taken in the direction of arrow A from FIG. 12, showing the third embodiment of the present microscope; and

FIG. 14 is a diagrammatic side view, taken in the direction of arrow B from FIG. 12, showing the third embodiment of the present microscope.

### DETAILED DESCRIPTION

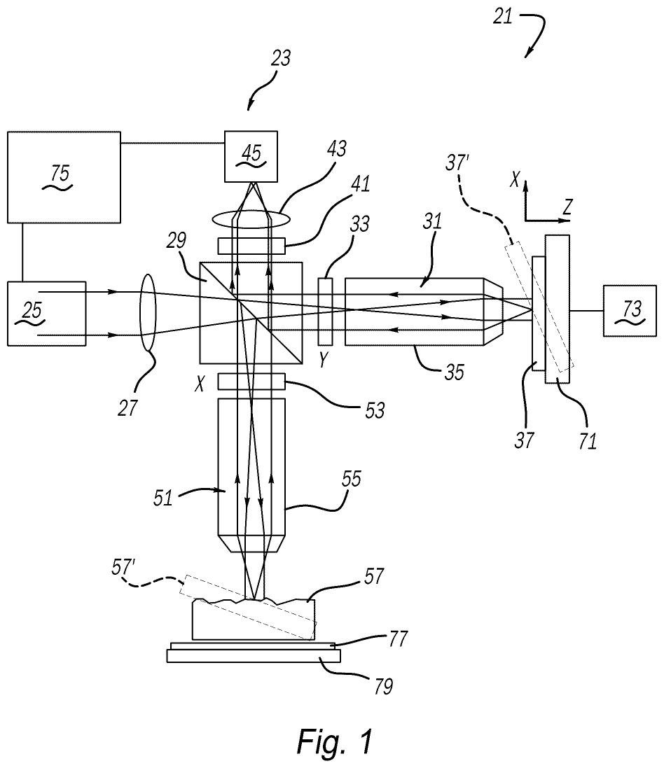

Referring to FIG. 1, a preferred embodiment of a microscope system 21 includes a Linnik interferometer 23. A light source 25 emits coherent light through a focusing lens 27 to a beam splitter 29. Beam splitter 29 thereafter sends a first portion of the light along a reference path or arm 31, through a Y-axis linear polarizer 33 and then through an objective lens 35, to a reference mirror 37.

It is noteworthy that objective lens 35 collimates the reference path light in this exemplary configuration. This enhances the image quality over traditional focused light emitted from an objective lens at a mirror and/or specimen. Reference mirror 37 phase-shifts the light reflected back therefrom through polarizer 33, objective lens 35 and beam splitter 29. The reflected reference light passes through a 45° quarter wave plate (“QWP”) 41 and a focusing camera lens 43, in the present example. The reflected reference light enters onto the light-sensitive matrix of a polarized color camera 45, or alternately a monochromic polarized camera for a higher pixel count and therefore image resolution.

Simultaneously, beam splitter 29 sends a second portion of the light from light source 25 along a sample path or arm 51, through an X-axis linear polarizer 53 and then through an objective lens 55, to a sample or workpiece specimen 57. The sample path light is reflected back from the sample through objective lens 55, polarizer 53 and beam splitter 29, whereafter it is sent through QWP 41 and camera lens 43 to camera 45. Interference of the two light rays, from the reference path and from the sample path, occurs at camera 45, which captures at least one image of sample 57, but in a phase shifted manner. Moreover, the phase shift is created by the sample and the reference mirror.

Preferably, the present Linnik interferometer uses identical objective lenses in both arms 31 and 51. In a laboratory setup for viewing solid or rigid samples, centerline axes of objective lenses 35 and 55 are generally perpendicular to each other. Polarizing optics 33 and 53 are preferably high-performance glass linear polarizers with an anti-reflection coating, such as model no. 47-216 from Edmund Optics, by way of non-limiting example, although a 2/2 plate may alternately be employed.

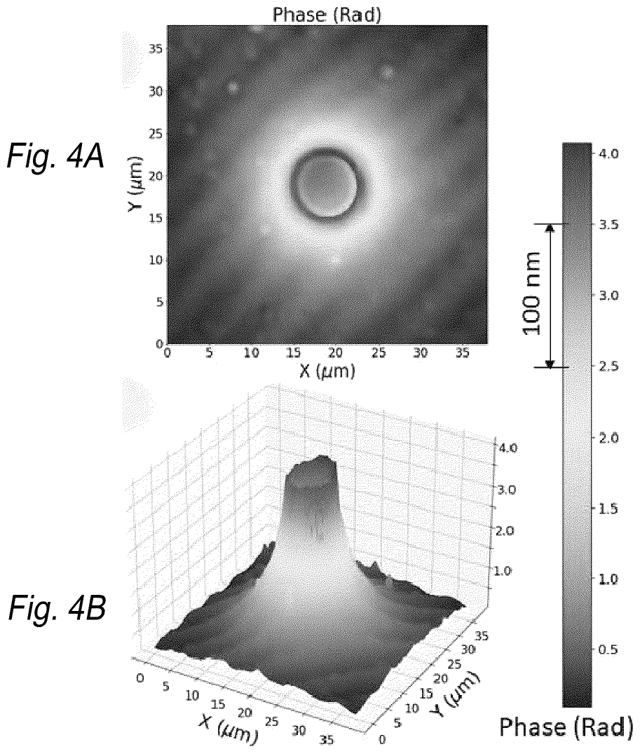

A light emitting diode (“LED”) (such as model no. M595F2 from Thorlabs) is the preferred light source 25, with a center wavelength λ₀ near 595 nm and a line width at half maximum Δλ of about 70 nm. Thus, a coherence length λ₀²/Δλ is about 5 μm which eliminates the presence of speckles, but needs symmetry of the interferometer arms. The expected results discussed hereinafter are obtained using air objectives with magnification 60× and NA=0.9. However, other types of objective lenses, including immersion lenses, may be employed especially with biological tissue samples such as those referenced in FIGS. 4A and 4B. Alternately, a laser can be employed for the light source. Alternately, the light may be pulsed. Alternately, the light emission is incoherent and has a coherence length λ²/Δλ longer than 50 μm.

Reference mirror 37 is preferably affixed to a mount 71 which may be tilted and moved by an actuator 73. Reference mirror 37 is preferably an atomically smooth silicon wafer. It is desired to obtain the same intensity reflection from the sample and reference mirror in order to obtain a high-resolution 3D image of the sample.

An exemplary actuator 73 for automated energization is a piezoelectric ceramic actuator having at least 1 nm positioning accuracy, which is automatically controllable by a programmable electronic controller 75 connected thereto by an electric circuit. The circuit also connects controller 75 to light source 25 and camera 45 for automatically controlling light emission and image capturing thereof. Optionally, a mount 77 can hold sample 57, and be tilted and moved though automated controller-energized movement of an actuator 79. Alternately, the reference mirror and/or sample may be manually tilted before or between light emissions and camera captures, but such takes considerably greater time and a highly skilled operator.

The solid lines illustrated for reference mirror 37 and sample 57 show their nominal positions, which sit on a generally planar surface perpendicularly oriented relative to the centerline and light emitting axis of the adjacent objective lenses 35 and 55, respectively. The dashed lines illustrate reference mirror 37′ and sample 57′ in their tilted positions which are offset angled from the objective centerline axes. The tilting offset angle is preferably 1-45° from their nominal positions and more preferably 1-30° from their nominal positions, to provide the desired phase-shifting and optionally, distortion correction, and also optionally, 3-dimensional imaging especially if a steep side surface of the specimen is being imaged.

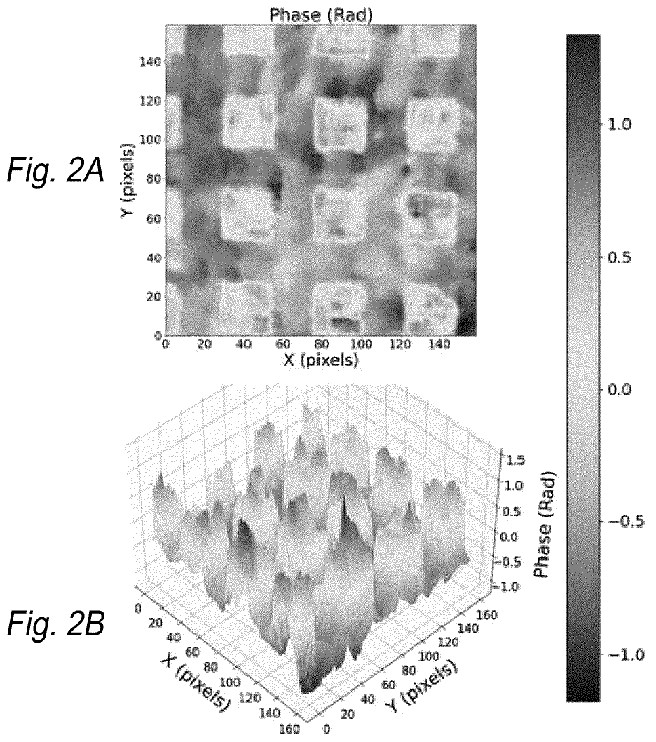

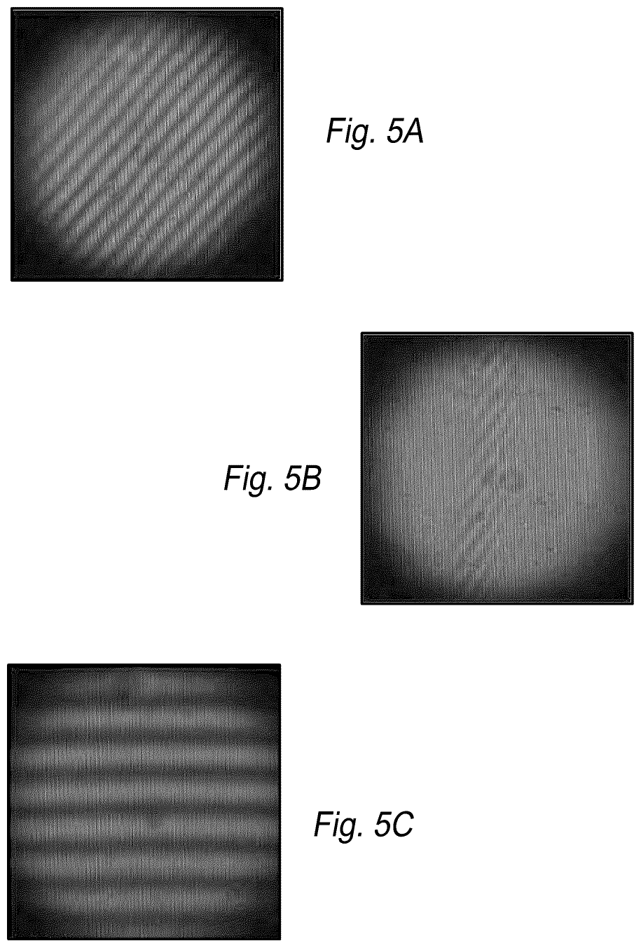

It is noteworthy that the present microscope system has the reference mirror in the tilted position when the light is emitting and the camera is capturing an image. The reference mirror titling advantageously gives improved X- and Y-direction lateral imaging resolution, as compared to when the mirror is in only the nominal position. This tilting obtains greater imaging accuracy for projecting edges of the sample, such as can be observed in FIG. 2A. The imaging results using the present microscope are the creation of a fringe pattern, examples of which can be seen in FIGS. 5A-C. Accordingly, the camera and controller obtain the three-dimensional image by processing interference patterns in images received by the camera. This 3D image can be obtained in both perpendicular and oblique positions of the sample and reference mirror with proper adjustment.

Phase-shifting method of phase calculations employed with the present microscope are set forth as follows. In two-beam interferometry, the electric fields of the reference wave and the wave from the sample summed up at the detector:

$$E ( x , y , t ) = {E}_{1} ( x , y ) {e}^{i ( ω t + {ϕ}_{1} ( x , y ) )} + {E}_{2} ( x , y ) {e}^{i ( ω t + {ϕ}_{2} ( x , y ) )} . \qquad ( 1 )$$

The detector registers the intensity of the wave, which is proportional to the square of the total electric field:

$$I ( x , y ) ∝ {\vert E ( x , y , t ) \vert}^{2} = {\vert {E}_{1} ( x , y ) \vert}^{2} + {\vert {E}_{2} ( x , y ) \vert}^{2} + {E}_{12} ( x , y ) + {E}_{12}^{*} ( x , y ) , \qquad ( 2 )$$

where E₁₂ (x,y)=E₁ (x,y) E₂*(x,y)exp(iΦ) and φ(x,y)=φ₁ (x,y)−φ₂ (x,y).

Neglecting the difference in the polarizations of the two beams, the following is obtained:

$$I ( x , y ) = B ( x , y ) + A ( x , y ) cos ( Φ ( x , y ) ) . \qquad ( 3 )$$

In most applications, all useful information is contained in the Φ(x,y) phase.

To calculate Φ(x,y) the method of phase-shifting interferometry is used. In this method different phase shifts & are obtained by displacing the reference mirror. As a result of this shift the following is obtained:

$${I}^{′} ( x , y ) = B ( x , y ) + A ( x , y ) cos ( Φ ( x , y ) + δ ) = B ( x , y ) + A ( x , y ) ( cos Φ ( x , y ) cos δ - sin Φ ( x , y ) sin δ ) . \qquad ( 4 )$$

From a series of such measurements, one can obtain the desired phase. For example, from a series of six measurements with phase shifts δ₁=0, δ₂=π/2, δ₃=π, δ₄=3π/2, δ₅=2π, δ₆=5π/2, obtains:

$${I}_{1} ( x , y ) = B ( x , y ) + A ( x , y ) cos ( Φ ( x , y ) ) , \qquad ( 5 )$$

$${I}_{2} ( x , y ) = B ( x , y ) - A ( x , y ) sin ( Φ ( x , y ) ) , \qquad ( 6 )$$

$${I}_{3} ( x , y ) = B ( x , y ) - A ( x , y ) cos ( Φ ( x , y ) ) , \qquad ( 7 )$$

$${I}_{4} ( x , y ) = B ( x , y ) + A ( x , y ) sin ( Φ ( x , y ) ) , \qquad ( 8 )$$

$${I}_{5} ( x , y ) = B ( x , y ) + A ( x , y ) cos ( Φ ( x , y ) ) , \qquad ( 9 )$$

$${I}_{6} ( x , y ) = B ( x , y ) - A ( x , y ) sin ( Φ ( x , y ) ) , \qquad ( 10 )$$

The exemplary single-shot light emission and camera imaging of the present microscope and method provide the I₁-I₄ values. Equations (5)-(10) are used to calculate the phase using the phase shift method without using a polarizing camera. In this case, the calibration described above is used. It is employed to determine the step size of the piezo stage so that at each step the phase shift is π/2. From the above formulas it is clear that I₅(x,y)=I₁(x,y) and I₆ (x,y)=I₂ (x,y). However, A(x,y) and B(x,y) may change slightly when the reference mirror is moved. Nevertheless, an acceptable calibration is obtained by achieving maximum agreement between I₁ and I₅, as well as I₂ and I₆.

The tangent of Φ(x,y) is calculated from above equations using several different formulas, for instance it is easy to check that:

$$tan [ Φ ( x , y ) ] = \frac{{I}_{4} - {I}_{2}}{{I}_{1} - {I}_{3}} . \qquad ( 11 )$$

It turns out, however, that different phase calculation formulas have different sensitivity to linear errors arising, for example, from calibration errors. The following is the most stable with respect to linear errors:

$$tan [ Φ ( x , y ) ] = \frac{{I}_{1} - 5 {I}_{2} - 2 {I}_{3} + 10 {I}_{4} - 3 {I}_{5} - {I}_{6}}{{I}_{1} + 3 {I}_{2} - 10 {I}_{3} + 2 {I}_{4} + 5 {I}_{5} - {I}_{6}} . \qquad ( 12 )$$

More specifically, polarizers 33 and 53 are perpendicular to each other so that the reflected light from sample 57 and reference mirror 37 do not interfere. QWP 41 is oriented at an angle of 45°, by way of example, so that the light reflected from the sample and the reference mirror are circularly polarized in opposite directions. The polarization sensitive camera 45 can simultaneously detect four images with different polarization 0°, 45°, 90° and 135°. The two circularly polarized waves interfere with each other, and a phase shift equal to twice the camera shift occurs between the interference patterns for different images. Therefore, four images with phase shifts δ₁=0, δ2=π/2, δ₃=π, δ₄=3π/2 are obtained from a single shot. Using the formula (11), the tangent of the phase shift Φ(x,y) is calculated between the reference mirror and the sample under study, either manually or automatically by the controller using programmed software instructions. Next, the desired image of Φ(x,y) is obtained using the procedure described above.

The total electric field of two waves reflected from the sample and the reference mirror with horizontal and vertical polarization, respectively, is equal to:

$$E ( x , y , t ) = {E}_{1} ( x , y ) ( \begin{matrix}1 \\ 0\end{matrix} ) exp [ i ( kz - ω t + {ϕ}_{1} ) ] + {E}_{2} ( x , y ) ( \begin{matrix}0 \\ 1\end{matrix} ) exp [ i ( kz - ω t + {ϕ}_{2} ) ] . \qquad ( 13 )$$

After passing through the QWP oriented at a 45-degree angle, these two waves acquire opposite circular polarizations:

$${E}^{′} ( x , y , t ) = \frac{1}{\sqrt{2}} ( \begin{matrix}1 & i \\ i & 1\end{matrix} ) E ( x , y ) = \frac{{E}_{1} ( x , y )}{\sqrt{2}} ( \begin{matrix}1 \\ i\end{matrix} ) exp [ i ( kz - ω t + {ϕ}_{1} ) ] + \frac{{E}_{2} ( x , y )}{\sqrt{2}} ( \begin{matrix}1 \\ - i\end{matrix} ) exp [ i ( kz - ω t + {ϕ}_{2} + π / 2 ) ] . \qquad ( 14 )$$

Finally, after a linear polarizer with an axis of transmission angle of θ from the horizontal, the following calculation is performed:

$${E}^{″} ( x , y , t ) = ( \begin{matrix}{cos}^{2} ( θ ) & cos ( θ ) sin ( θ ) \\ cos ( θ ) sin ( θ ) & {sin}^{2} ( θ )\end{matrix} ) {E}^{′} ( x , y , t ) = \frac{{E}_{1} ( x , y )}{\sqrt{2}} ( \begin{matrix}cos ( θ ) \\ sin ( θ )\end{matrix} ) exp [ i ( kz - ω t + {ϕ}_{1} + θ ) ] + \frac{{E}_{2} ( x , y )}{\sqrt{2}} ( \begin{matrix}cos ( θ ) \\ sin ( θ )\end{matrix} ) exp [ i ( kz - ω t + {ϕ}_{2} + π / 2 - θ ) ] \qquad ( 15 )$$

Then, the intensity of light is calculated:

$$I ( x , y ) ∝ {E}^{″†} ( x , y , t ) {E}^{″} ( x , y , t ) = \frac{1}{2} [ {\vert {E}_{1} ( x , y ) \vert}^{2} + {\vert {E}_{2} ( x , y ) \vert}^{2} + {E}_{12} ( x , y ) + {E}_{12}^{*} ( x , y ) ] , \qquad ( 16 )$$

where [symbol] means transpose and complex conjugation and

$${E}_{12} ( x , y ) = {E}_{1} ( x , y ) {E}_{2}^{*} ( x , y ) exp [ i ( {ϕ}_{1} - {ϕ}_{2} - π / 2 + 2 θ ) ] . \qquad ( 17 )$$

The following equation is a result:

$$I ( x , y ) = B ( x , y ) + A ( x , y ) cos ( Φ ( x , y ) + 2 θ ) , \qquad ( 18 )$$

where the unimportant constant shift π/2 is included in Φ(x,y).

FIGS. 2A and 2B show an expected longitudinal resolution of the order of 50 nm. This is due to the use of a 632.8 nm He—Ne laser as the light source.

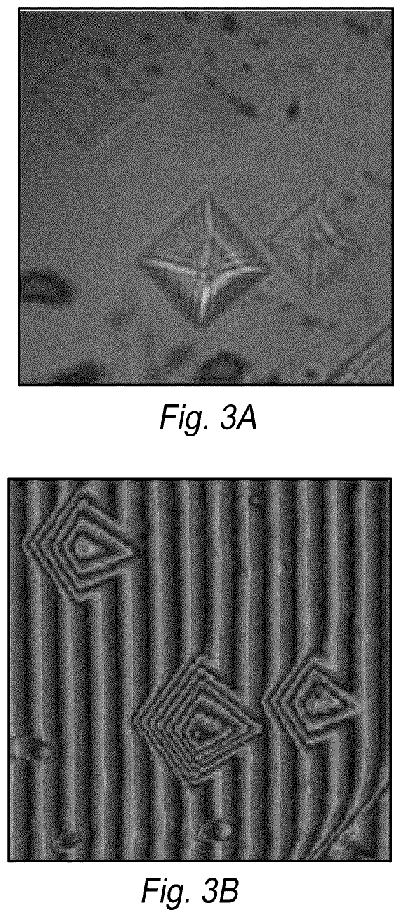

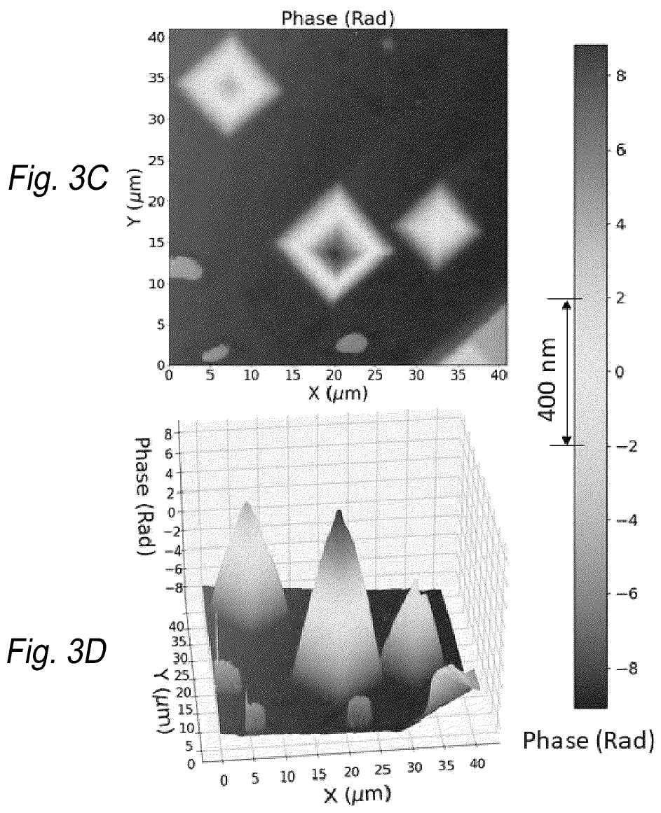

FIGS. 3A-D show expected images from the surface of an artificial diamond sample, by way of a nonlimiting example, using the phase-shifting process with the present microscope of FIG. 1. Using microscope 21, protrusions projecting from a surface of the diamond sample are in the form of rectangular pyramids. The present apparatus and method allow for a determination of the height and form of the protrusions. FIG. 3A shows an image of a pyramid protrusion using the microscope in reflective light, FIG. 3B shows an image thereof with phase Φ(x,y) calculated using formula (12), a contour graphic image thereof can be observed in FIG. 3C, and a 3D image thereof is shown in FIG. 3D.

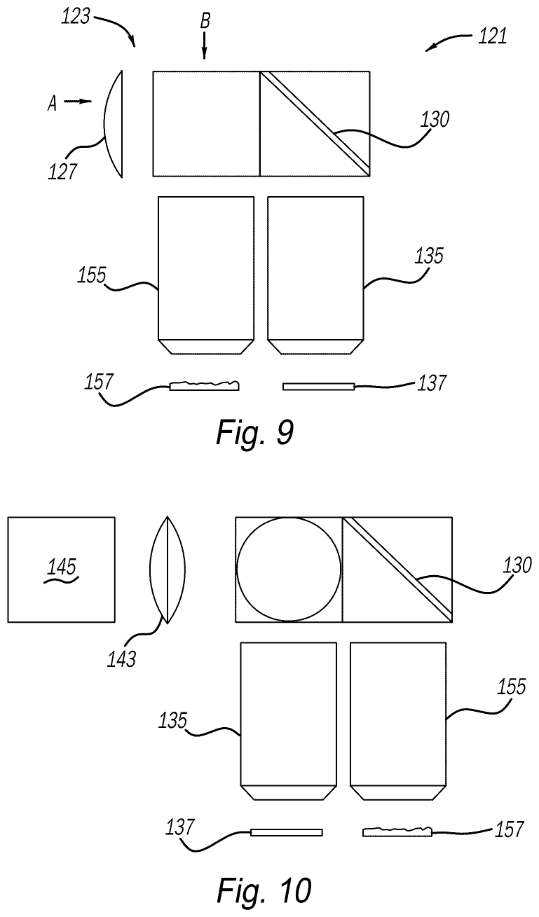

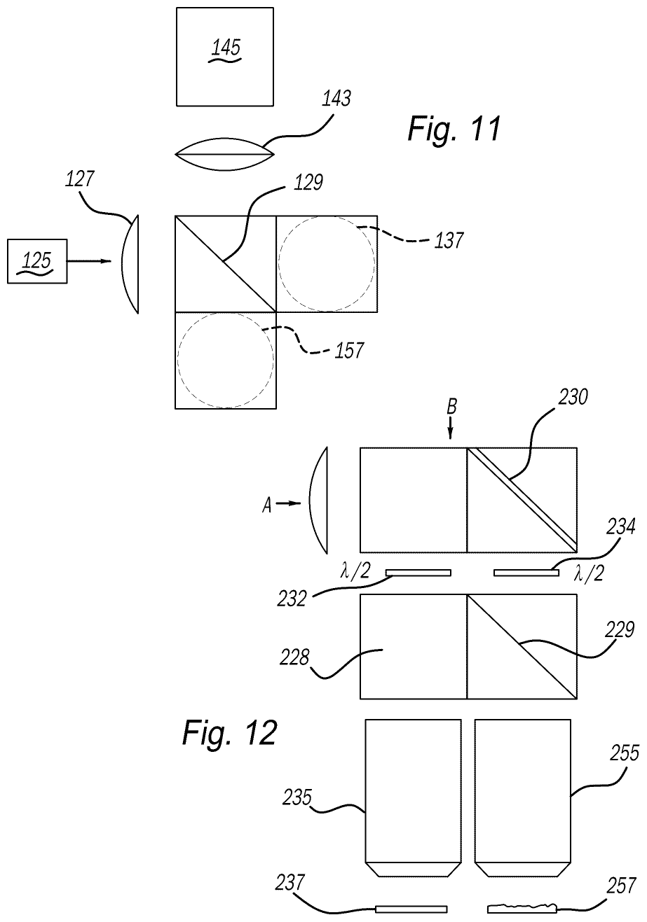

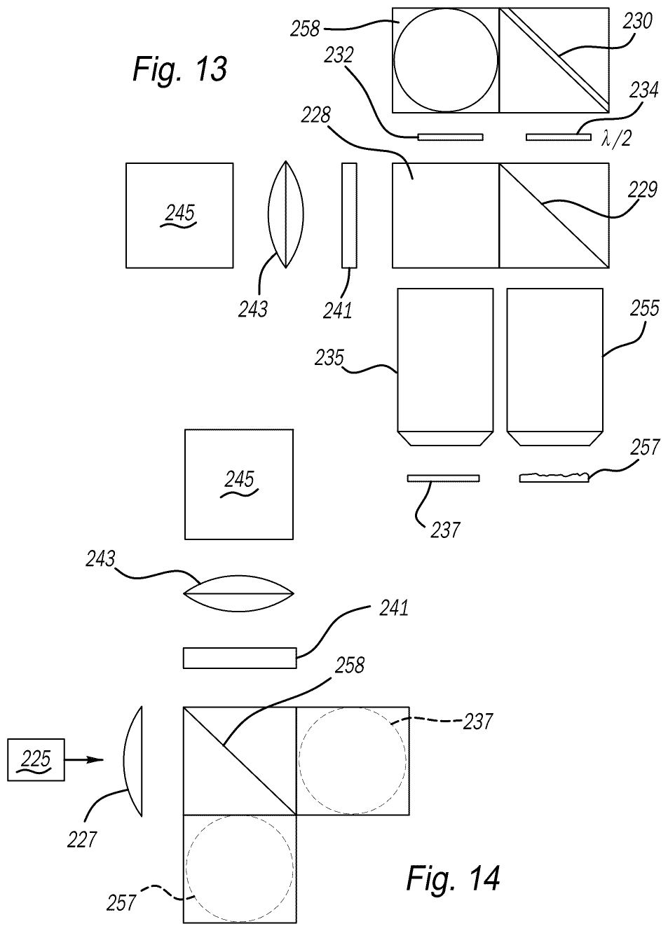

The present microscope and method are also useful for imaging biological samples such as a tissue cell. As a non-limiting example, FIGS. 4A and B show expected results of erythrocyte, also known as a red blood cell, images captured by the camera. The blood is applied in a thin layer to a glass slide and observed immediately without the use of a coverslip. Thus, in this figure the reflective surface of the red blood cell can be observed, slightly projecting in a somewhat frustoconically tapering manner above a surface of a liquid. It is noteworthy that the vertical scale is different than in the nominal plane perpendicular to the objective centerline. The diameter of the red blood cell itself is about 7 μm, and the part protruding above the surface of the liquid is about 0.3 μm. Accordingly, the high X-, Y- and Z-direction resolution of the image is enhanced with the present microscope and method. The vertically oriented microscope configurations of FIGS. 9-14 may be better suited for the immersive biological tissue sample, as will be later discussed in greater detail.

In a laboratory situation with manual reference mirror orienting, continuous light emission is employed. The user monitors a camera image on an output computer screen in real-time, observing its transformation as the reference mirror is tilted and/or rotated. On the screen, the user observes either an image of the sample or an interference pattern with the desired position of the reference mirror. The sample and the reference mirror is then moved to optimize the image. Additionally, the reference mirror can be moved along the Z-axis of the lens using a piezoelectric drive, which is employed in conjunction with the phase-shifting method.

If the image displayed on the screen is satisfactory, then one or more images are captured by the camera and stored in the computer memory for subsequent processing. The distinction between the “single shot” and “phase-shifting” methodologies is that the former yields all the requisite information from a single capture, whereas the latter necessitates the initial calibration of the apparatus and the subsequent acquisition of six images through the sequential movement of the reference mirror. At the instant of capturing an image, all components are stationary.

The angle of inclination of the reference mirror should be approximately equal in absolute value to the angle of inclination of the sample and opposite in sign. The precise installation of the reference mirror is carried out by the appearance of the interference pattern on the screen. This process can be automated using automated pattern recognition techniques based on artificial intelligence and/or a genetic learning algorithm.

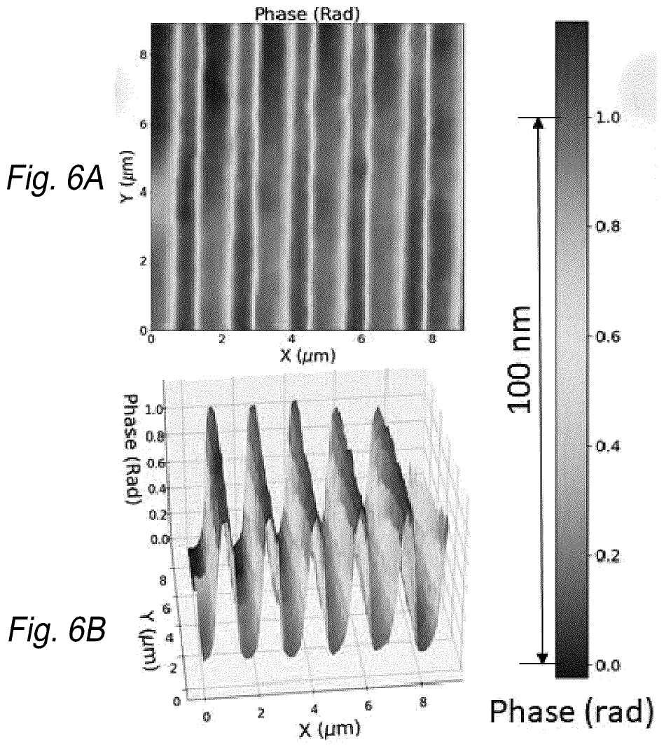

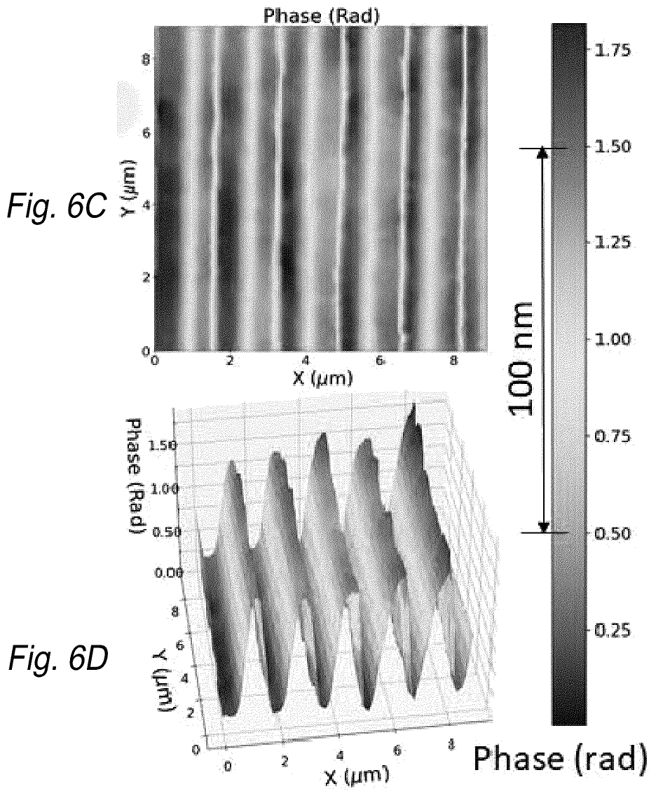

FIGS. 5A-C show the interference pattern for various positions of a sample and the reference mirror. The exemplary sample here is a reflective grating. In FIG. 5A, the grating sample and the reference mirror are located substantially perpendicular to the optical lens axis, while in FIG. 5B, the grating sample is rotated approximately 15° degrees, and in FIG. 5C, the reference mirror is rotated to the same angle of approximately 15°, the same as the grating sample. The fringe pattern in FIG. 5A enables accurate surface shape calculation, as shown in FIGS. 6A and B. Rotating the sample reveals a narrow strip with a complex internal structure in the fringe pattern. The width of this strip is determined by the coherence length of the light and deciphering the image in this instance is impossible. This is solved by rotating the reference mirror to the same angle as the sample, which produces a fringe pattern suitable for surface calculations per FIGS. 6C and D, where the calculated grating profiles are nearly identical in both cases. The greatest contrast in the interference pattern is achieved when the intensity of light from the sample and the reference mirror are equal.

The capability to observe the shape of a surface at a significant angle to the lens axis with super-resolution provides extensive opportunities for studying objects with non-flat shapes, such as a convex hemisphere, without rotating them. When scanning such surfaces, it is only necessary to rotate the reference mirror to the desired angle and adjust the lighting system. The phase-shifting method of phase calculation gives reliable results. The optimal formula for calculating the phase effectively eliminates any linear errors it introduces. Optionally, a two-stage pneumatic vibration isolator can be utilized to reduce vibrations.

The use of the polarized camera with the present Linnik interferometer for single-shot measurements makes the microscope almost insensitive to vibrations and allows the observation of moving objects. The present microscope and method have additional advantages including the symmetrical design of the interferometer, which makes it easy to operate with incoherent light sources while chromatic aberrations are eliminated. Also, the symmetrical design allows for quick replacement of one pair of equivalent objective lenses with another with minimal adjustment of the optical system.

Moreover, a simple procedure for replacing the reference mirror allows one to obtain optimal conditions for observing interference fringes. By rotating the reference mirror, the appearance of the interference pattern can be optimized for further phase calculations. Rotating the reference mirror by a significant angle can compensate for the non-optimal position of the sample when using objective lenses with a large numerical aperture. Furthermore, phase-shifting the reflected reference path can optionally be performed by automatically oscillating the reference mirror using a piezoelectric crystal, oscillating such that the camera can take six (or more) images per half-oscillation cycle. The images can be time-stamped for subsequent image processing by the software instructions run by the controller. In another configuration, titling of the reference mirror relative to the reference objective, can occur in multiple dimensions, such as along two different rotational directions.

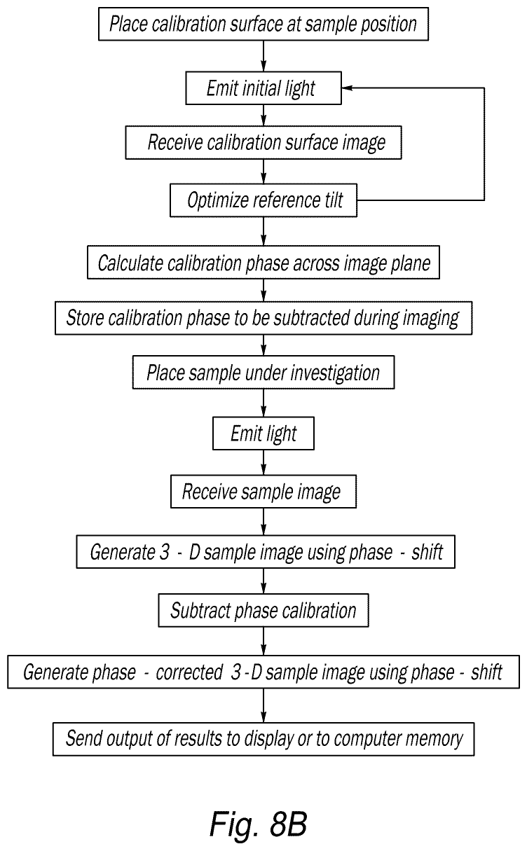

An optional construction and method include mounting a target sample to be imaged next to a reference sample, calibrating an optical setup of the microscope using the reference sample in order to automatically substantially eliminate phase distortions by image processing software prior to capturing the image of the target sample. An exemplary automated software program used by controller 75 is shown in FIG. 8B where one or more programmed instructions and one or more controllers automatically operate within a method including: placing a calibration surface at a sample position, emitting an initial light from the light source, receiving a calibration surface image, optimizing a reference mirror tilting angle (repeating as necessary), calculating a calibration phase across an image plane, storing the calibration phase to be subtracted during imaging, placing the sample under investigation, emitting a subsequent light beam, receiving a sample image, generating a 3D sample image using the phase-shift, subtracting the phase calibration, generating a phase-corrected 3D sample image using the phase-shift, and sending an output of the results to the computer display or memory.

An optional construction and method include using a polarizing camera with pixels dedicated to four different polarization angles, to perform the image capturing. In a further optional construction and method, the input light emission is emitted from a pulsed laser to obtain time-resolved measurements, based on delay between a first light pulse that initiates motion and a high-speed camera that detects the motion. In another optional construction and method, the microscope objectives are used in index-matching fluid and the objectives are substantially vertically oriented. In an optional arrangement, all of the optics, such as the lenses, the beam splitter, and the reference mirror, are compatible with short-wavelength light of 150-250 nm, to achieve high spatial and axial resolution.

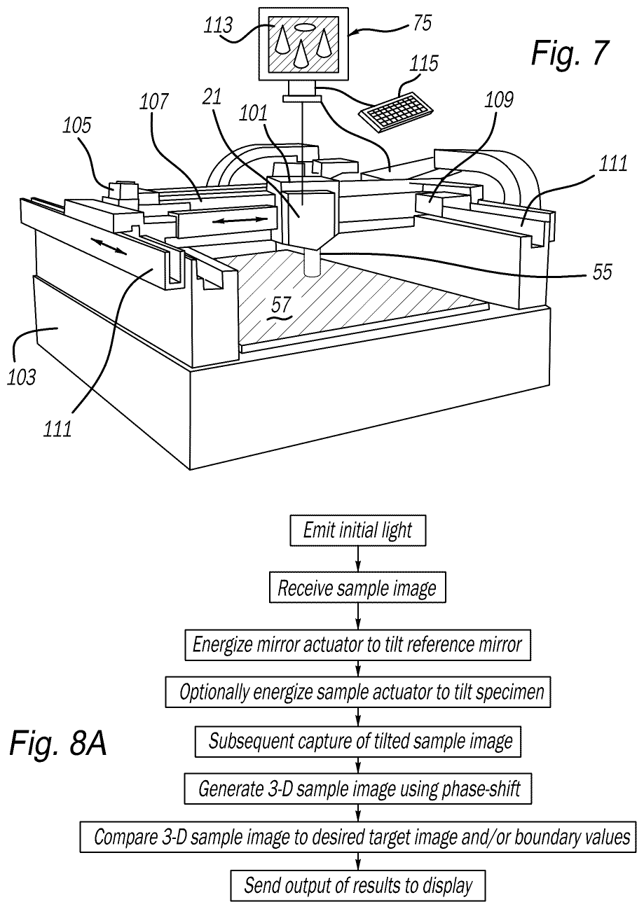

In an industrial production arrangement, microscope 21 is mounted to a carriage 101 of a gantry 103, in the alternate use shown in FIG. 7. A stepper motor or other actuator 105 moves carriage 101 in a lateral X direction along a laterally elongated beam 107 and an actuator 109 linearly moves beam 107 along Y direction on a coupled pair of outboard tracks 111. Thus, microscope spans above and is movable side-to-side and back-and-forth along a workpiece sample 57. This construction is employed to scan and image the sample, such as an array of silicon microchips or the like, to determine if the surface thereof has a desirable manufactured characteristic within a predetermined tolerance range, such as smoothness or conversely properly created projections thereon, a consistent thickness, or the like. The process includes: moving at least a portion of the microscope over the sample, which includes at least one of: an electronic circuit, fabricated wafer, artificial diamond, or display screen; automatically using first software instructions, stored in non-transient memory, to compare the image of the specimen to a desired target image or range values; and automatically using second software instructions to determine if scanned surface characteristics of the image are acceptable based at least in part on the comparison.

Actuators 105 and 109, and microscope 21 are connected to controller 75 via an electrical circuit. A display screen 113 and input keyboard 115 are also connected to controller 75, although alternate input controls and output signals can be provided. The controller includes a microprocessor which runs the software instructions, which are stored in non-transient RAM or ROM memory. One such automated software program used by controller 75 is shown in FIG. 8A. One or more programmed instructions and one or more controllers automatically cause the light source to emit light, receive the sample image with the camera, energize the mirror actuator to tilt the reference mirror, optionally energize the sample actuator to tilt the specimen, subsequently capture the tilted sample image with the camera, generate a 3D sample image using phase-shifting, compare the 3D sample image to a desired target image and/or boundary range values, and send an output of the results to the computer display.

In one configuration, at least a 1 cm² or diameter area of the sample can be imaged. In another configuration, an area to be imaged can be as small as 1 μm²-1 mm² or diameter, or much larger if using a telescope. For example, an image may be about 20 μm diameter.

Reference should now be made to FIGS. 9-14 for alternate constructions of the present imaging microscope 121 with an interferometer 123. In both of these embodiments, a reference mirror 137 and a sample 157 are on generally horizontal planes while reference and sample objective lenses 135 and 155, respectively, are generally vertically oriented. This arrangement is well suited for immersion objective lenses for biological tissue use. The additional mirror-induced distortions can be compensated with calibration and subsequent image correction. All of the tilting, image capture and controller features of the first embodiment are also applicable to the present exemplary embodiments.

More specifically, FIGS. 9-11 illustrate a second embodiment microscope 121 including a light source 125, an initial objective focusing lens 127, a beam splitter 129, and a reflective mirror 130. Sample objective lens 155 and reference objective lens 135 have centerlines axes that are substantially parallel to each other and generally vertically orientated, perpendicular to a nominal orientation of horizontally oriented referenced mirror 137 and sample 157. Collimated light is emitted from objective lenses 135 and 155 to reference mirror 137 and sample 157. The reflected light from the reference mirror and sample are focused by camera lens 143 and received by a non-polarized camera 145. It is noteworthy that polarizers are not employed in this optional configuration, which improves camera resolution.

A third embodiment microscope 121 is illustrated in FIGS. 12-14. This exemplary configuration includes a light source 225, an initial objective focusing lens 227, beam splitters 228 and 229, and a reflective mirror 230. λ/2 polarizing optics 232 and 234 are aligned with the beam splitters, and a 45° QWP 241 is located between beam splitter 228 and camera lens 243. Sample objective lens 255 and reference objective lens 235 have centerlines axes that are substantially parallel to each other and generally vertically orientated, perpendicular to a nominal orientation of horizontally oriented referenced mirror 137 and sample 157. Collimated light is emitted from objective lenses 235 and 255 to reference mirror 237 and sample 257. The reflected light from the reference mirror and sample are focused by camera lens 243 and received by polarized camera 245.

Light source 225 emits linearly polarized light. If a non-polarizing beam splitter 258 is used, either λ/2 plates 232 and 234, or polarizing plates are used. If a polarizing beam splitter 258 is used, however, plates 232 and 234 can be dispensed with, and the light from source 225 can be unpolarized.

While various configurations have been disclosed hereinabove, additional variations may be employed with the present laser system. For example, additional or different optic components may be used with the present system, although certain advantages may not be realized. Furthermore, additional, or modified software steps and electrical circuits may be provided, although some benefits may not be achieved. As another example, a half wave plate may be employed instead of the quarter wave plate, with the half wave plate and/or polarizer and/or beam splitter located at the light source, although all of the present advantages may not be obtained. A telescope lens can be substituted for the objective lenses in an alternate configuration. Structural and functional features of each embodiment may be interchanged between other embodiments disclosed herein, and all of the claims may be multiply dependent on the others in all combinations. It is intended by the following claims to cover these and any other departures from the disclosed embodiments which fall within the true spirit and scope of the present invention.

The invention claimed is:

1. A method of using a microscope including an interferometer, the method comprising:
(a) emitting an input light emission to the interferometer;
(b) splitting the light emission into a reference path and a sampling path;
(c) changing an optical characteristic of the light emission in the reference path with a reference objective lens;
(d) reflecting the light emission in the reference path with a reference mirror;
(e) changing an optical characteristic of the light emission in the sampling path with a sampling objective lens;
(f) reflecting the light emission in the sampling path with the sample;
(g) tilting the reference mirror relative to the reference objective lens during the light emission;
(h) capturing a phase-resolved image of the sample with a detector; and
(i) obtaining a 3-dimensional image of the sample from the captured image.

2. The method of claim 1, further comprising:
polarizing the light emission of the reference path between the splitting and a reference mirror;
polarizing the light emission of the sampling path between the splitting and a sample; and
collimating the light emission from the reference lens to the reference mirror.

3. The method of claim 2, further comprising:
the light emission is incoherent and has a coherence length λ²/Δλ longer than 50 μm; and
transmitting the reflected light emission from the reference path and the reflected light emission from the sampling path to the detector which is a non-polarized camera.

4. The method of claim 1, further comprising:
passing the reflected light from at least one of the paths through a quarter-wave plate which is located between the splitter and the detector;
the reflected light emission from the sampling path having orthogonal polarization, and the light emission being coherent light; and
the detector being a polarized camera.

5. The method of claim 1, further comprising:
causing the reference mirror to be aligned with a centerline axis of the reference lens, the reference mirror including a flat, polished silicon wafer; and
creating the image from at least a 1 cm² area of the sample.

6. The method of claim 1, further comprising phase-shifting the reflected reference path by oscillating the reference mirror so that the camera captures at least six images per half-oscillation cycle.

7. The method of claim 1, further comprising automatically controlling an actuator by a programmable controller, to cause the tilt of the reference mirror relative to the reference objective lens during imaging to at least one of: correct for phase distortions, or perform the phase-shifting.

8. The method of claim 1, further comprising tilting the reference mirror relative to the reference objective lens by 15-45° off of a nominal plane perpendicular to a centerline direction of the light emission emitted from the reference objective or telescopic lens to the reference mirror.

9. The method of claim 1, further comprising titling the reference mirror relative to the reference objective, in multiple dimensions.

10. The method of claim 1, further comprising tilting the sample relative to the sampling objective lens during the light emitting.

11. The method of claim 1, wherein:
the reference and sample lenses are objective lenses;
an axis of a polarizer associated with the reference path is offset oriented substantially perpendicular to an axis of a polarizer associated with the sampling path;
an axis of a wave plate, located between the splitter and the detector, is offset oriented from the axes of the polarizers; and
the detector is a monochromatic camera.

12. The method of claim 1, wherein:
the interferometer is a Linnik interferometer;
the sampling objective lens and the reference objective lens are oriented substantially parallel to each other with their centerlines being located in a substantially vertical direction;
the sample and the reference mirror are located below the objective lenses; and
the camera is substantially horizontally aligned with a wave plate and a pair of beam splitters.

13. The method of claim 1, further comprising oscillating the reference mirror to create reference phases used to retrieve height information at a rate that matches a high-speed camera image acquisition rate used for the image capturing.

14. A method of using a microscope including an interferometer, the method comprising:
(a) emitting an input light emission to the interferometer;
(b) splitting the light emission into a reference path and a sampling path;
(c) changing an optical characteristic of the light emission in the reference path with a reference objective or telescopic lens;
(d) reflecting the light emission in the reference path with the reference mirror;
(e) polarizing the light emission of the reference path between the splitting and the reflecting with the reference mirror;
(f) changing an optical characteristic of the light emission in the sampling path with a sampling objective or telescopic lens;
(g) reflecting the light emission in the sampling path with a sample;
(h) polarizing the light emission of the sampling path between the splitting and the reflecting with the sample;
(i) phase-shifting at least one of the reflected light emissions;
(j) transmitting the reflected light emission from the reference path and the reflected light emission from the sampling path to a polarized detector; and
(k) capturing an image of the sample with the detector using a single shot illumination.

15. The method of claim 14, further comprising:
a quarter- or half-wave plate located between the splitter and the polarized detector;
the light emission being a coherent light from a light emitting diode;
the detector being a polarized camera.

16. The method of claim 14, wherein:
the reference mirror includes a flat, polished silicon surface; and
the image includes at least a 100 μm² area of the sample.

17. The method of claim 14, further comprising tilting the reference mirror relative to the reference objective lens during imaging, and collimating the light emission from the reference objective to the reference mirror.

18. The method of claim 14, further comprising automatically controlling an actuator by a programmable controller, to tilt the reference mirror relative to the reference objective or telescopic lens during imaging to correct for phase distortions.

19. The method of claim 14, further comprising tilting the reference mirror relative to the reference objective lens by 15-45° off of a nominal plane perpendicular to the light emission emitted from the reference objective lens to the reference mirror.

20. The method of claim 14, further comprising tilting the sample relative to the sampling objective lens during imaging.

21. The method of claim 14, wherein the image capturing is performed with a polarizing camera that phase-shifts by using four different polarization angles.

22. The method of claim 14, further comprising:
collimating the polarized and emitted light on the reference mirror and sample with the lenses which are objective lenses;
offset orienting an axis of the polarizer associated with the reference path, substantially perpendicular to an axis of the polarizer associated with the sampling path;
offset orienting an axis of a wave plate, located between the splitter and the detector, from the axes of the polarizers; and
capturing the image with the detector which is a polarized camera.

23. The method of claim 14, further comprising:
moving at least a portion of the microscope over the sample, which includes at least one of: an electronic circuit, fabricated wafer, artificial diamond, or display screen;
automatically using first software instructions, stored in non-transient memory, to compare the image of the specimen to a desired target image or range values; and
automatically using second software instructions to determine if scanned surface characteristics of the image are acceptable based at least in part on the comparison.

24. The method of claim 14, wherein the sample is a biological tissue, and the single-shot is used to create the image of the biological tissue with no greater than a 3 ms exposure time, with low sensitivity to vibrations.

25. The method of claim 14, wherein:
the interferometer is a Linnik interferometer;
the sampling objective lens and the reference objective lens are oriented substantially parallel to each other with their centerlines being located in a substantially vertical direction;
the sample and the reference mirror are located below the objective lenses; and
the camera is substantially horizontally aligned with a wave plate and a pair of beam splitters.

26. The method of claim 14, further comprising mounting a target sample to be imaged next to a reference sample, calibrating an optical setup of the microscope using the reference sample in order to automatically substantially eliminate phase distortions by image processing software prior to capturing the image of the target sample.

27. The method of claim 14, further comprising using a polarizing camera with pixels dedicated to four different polarization angles, to perform the image capturing.

28. The method of claim 14, wherein the input light emission is emitted from a pulsed laser to obtain time-resolved measurements, based on delay between a first light pulse that initiates motion and a high-speed camera that detects the motion.

29. The method of claim 14, wherein the microscope objectives are used in index-matching fluid and the objectives are substantially vertically oriented.

30. The method of claim 14, wherein the lenses, the beam splitter, and the reference mirror are compatible with short-wavelength light of 150-250 nm, to achieve high spatial and axial resolution.

31. The method of claim 14, further comprising pulsing the light source and obtaining an image from a single pulse of the light source with a polarizing camera, and mitigating motion of the sample when obtaining the image.

32. The method of claim 14, further comprising:
(a) placing a calibration surface at a sample position;
(b) emitting an initial light output from a light source;
(c) receiving a calibration surface image;
(d) optimizing a reference mirror tilting angle;
(e) calculating a calibration phase across an image plane;
(f) storing the calibration phase to be subtracted during imaging;
(g) placing the sample in an imaging position;
(h) subsequently performing the light emission;
(i) receiving the image of the sample;
(j) generating a 3D sample image using the phase-shifting;
(k) subtracting the phase calibration;
(l) generating a phase-corrected 3D sample image using the phase-shifting; and
(m) sending an output of the results to an electronic display or memory.

33. A microscope system comprising:
(a) a light source configured to emit light;
(b) an interferometer comprising:
i. a beam splitter configured to split the light emission into a reference path and a sampling path;
ii. a reference polarizer configured to polarize the light emission in the reference path;
iii. a sampling polarizer configured to polarize the light emission in the sampling path; and
iv. a polarized camera;
(c) a reference objective or telescopic lens located between the reference polarizer and the reference mirror;
(d) a sampling objective or telescopic lens located between the sampling polarizer and a sample location;
(e) the camera being configured to receive a sample image as sent back through the sampling objective or telescopic lens; and
(f) a programmable controller connected to the camera, the controller being configured to automatically:
i. generate a sample image from the sample image received by the camera,
ii. compare the generated sample image to a target image or boundary values, and
iii. detect a fringe pattern with the phase-shift using light polarization with a single illumination shot of the light.
